(19) United States
(12) Patent Application Publication
(10) Pub. No.: US 2013/0141115 A1
(43) Pub. Date: Jun. 6, 2013

(54) Process and Installation for Inspection and/or Sorting Combining Surface Analysis and Volume Analysis

(71) Applicants: Pellenc Selective Technologies, Pertuis (FR); Universite De Savoie, Chambery (FR)

(72) Inventors: Antoine BOURELY, LA TOUR D'AIGUES (FR); David MOUNEYRAC, MANSAC (FR); Jean-Louis COUTAZ, SAINT CASSIN (FR); Frederic GARET, SAINT CASSIN (FR); Benjamin BLAMPEY, RUMILLY (FR)

(73) Assignees: UNIVERSITE DE SAVOIE, CHAMBERY (FR); PELLENC SELECTIVE TECHNOLOGIES, PERTUIS (FR)

(21) Appl. No.: 13/705,351

(22) Filed: Dec. 5, 2012

(30) Foreign Application Priority Data
Dec. 6, 2011 (FR) 1161200

(51) Int. Cl. G01N 21/17; G01N 23/223; G01J 3/28; G01N 22/00

(52) U.S. Cl. CPC G01N 21/17; G01N 22/00; G01N 23/223; G01J 3/28
USPC 324/637; 250/206; 378/53; 250/338.1; 378/44; 356/318; 250/340

(57) ABSTRACT

Automatic process and installation for inspecting and/or sorting objects or articles belonging to at least two different categories, and made to advance approximately in a single layer, for example on a conveyor belt or a similar transport support. The process includes subjecting the advancing flow of objects or articles to at least two different types of contactless analysis by radiation, whose results are used in a combined manner for each object or article to perform a discrimination among these objects or articles and/or an evaluation of at least one characteristic of the latter, the analyses including at least one surface analysis process able to determine the physical and/or chemical composition of the outer layer of an object or article exposed to the radiation used in this process, and at least one volume analysis process able to determine the equivalent thickness of material of the same object or article.

This invention relates to the field of rapid characterization of advancing objects, articles or the like, in particular waste materials, for the purpose of discriminating among them and/or evaluating them, and it has as its object a process and an installation for the inspection and/or the automatic sorting of objects, articles or the like.

Numerous solutions have already been proposed within the scope of the above-mentioned field.

Thus, numerous processes for measurement on the surface or at slight penetration have been developed for automatic sorting applications.

By way of example, FR-A-2 895 688 describes a process and an automated machine for inspection and sorting of non-metallic objects in which the upper layer of each object advancing on a conveyor belt is subjected temporarily to a heat radiation. A thermographic analysis of the object is then performed so as to determine the type of object. This technique is used in particular for making a distinction of papers, cardboard, etc. This distinction process has limits in that it is not possible to make a distinction between a light or coated cardboard (flat cardboard) and certain magazines. In fact, the cover of the magazine, when it is thick, has the same thermal behavior as a light or coated cardboard. Thus, during sorting, the magazine will be considered as a light or coated cardboard and will therefore not be well recovered. A second limitation encountered by this process is connected to the moisture of the objects advancing on the conveyor belt. A moist object has a behavior that is different from a dry object, the difference being all the greater as the level of moisture is greater. The error in the sorting is then increased.

EP-A-124 350 describes a system of surface analysis using infrared spectroscopy. This system makes possible the differentiation of objects of different categories such as different plastics (PET, PETG, PS, ABS, etc.). It is the spectroscopic surface analysis of the object that enables to perform this differentiation.

Moreover, other processes that make it possible to measure the thickness of an object have been developed. These processes use transmission technologies such as, for example, the different X-ray or Gamma-ray technologies, or lower-energy technologies such as hyperfrequencies.

In the field of hyperfrequencies, numerous patents having systems for characterization of materials have been proposed.

Certain of these systems using microwave radiation exist for the measuring of moisture, such as, for example, those described in U.S. Pat. No. 5,845,529 and U.S. Pat. No. 5,333,493. These U.S. patent applications disclose systems that make it possible to measure the moisture level in thick bales of dry products, such as, for example, bales of tobacco, cotton, wood, for the first U.S. document cited above and the level of moisture in coal for the second U.S. document cited above. To do this, the microwave signal is sent through the object to be measured. With a measurement of amplitude and phase, it is then possible to determine the level of moisture of the object being tested. We note that these measurements are not intended to distinguish bales of different compositions, apart from the differences of moisture level.

Other publications exist that present solutions in the field of hyperfrequencies that make possible the characterization of materials. By way of example, the document FR-A-2 906 369 that describes a hyperfrequency device for inspection and detection of defects in mainly homogenous materials such as a roll of fiberglass insulation can be cited. This device is composed of an emitting system that illuminates the object to be characterized. At reception, an array of antennas enables to pick up the emitted signal. As a function of the amplitude and the phase of the signal, it is possible to determine the defects.

Finally, particular associations of different technologies have already been published. This is the case, for example, of the document US-A-20100085066 in which a hyperfrequency technology is combined with an X-ray technology to check pieces of luggage in airports. In this document, the hyperfrequency technology enables to increase the inspection speed of the luggage. The pieces of luggage are first of all subjected to a hyperfrequency analysis. This analysis enables to obtain an image of the piece of luggage that is advancing on the conveyor. This image is then compared to predefined models. If the hyperfrequency analysis shows an uncertainty, the piece of luggage is then subjected to an additional and separate analysis with X-rays. Since the hyperfrequency analysis from a software point of view is easier to put in place, this association of technologies enables to increase the inspection rate because only the questionable pieces of luggage are analyzed with X-rays.

The essential object of this invention consists in proposing a solution that, in the context indicated at the beginning of this document, enables to improve in a significant way the quality of sorting and/or the precision of measurement of certain characteristics or of certain parameters of advancing objects, articles or the like, for example on a conveyor. The proposed solution would also have to allow, if necessary, an overall quantification of the flow, by type of material or by characteristic to be evaluated.

For this purpose, the invention has as its first object an automatic process for inspection and/or sorting of objects, articles or the like, belonging to at least two different categories and made to advance approximately in a single layer, for example on a conveyor belt or a similar transport support, a process characterized in that it consists in subjecting the advancing flow of objects, articles or the like to at least two different types of contactless analysis by radiation, whose results are used in a combined manner for each object, article or the like, to perform a discrimination among these objects, articles or the like and/or an evaluation of at least one characteristic of the latter, the analyses used comprising, on the one hand, at least one surface analysis process able to determine the physical and/or chemical composition of the upper or outer layer of an object or the like exposed to the radiation used in this process and, on the other hand, at least one volume analysis process able to determine the equivalent thickness of material of the same object or the like.

In this document, equivalent thickness is called the total amount of vertically present material of the surface element, assuming that the material remains the same under the visible surface, and without taking into account possible gaps.

Consequently, the invention is based on the combined use of at least one surface recognition or analysis technology and at least one volume analysis technology, resulting in at least one double analysis applied to the group of advancing objects, articles or the like.

Preferentially, the invention envisions the processing of the objects, articles or the like by a surface analysis process and by a volume analysis process, said objects, articles or the like being subjected successively or simultaneously to each of the two above-cited analysis processes during their single-layer flow advancement.

Thus, each surface element of an object or article that advances is subjected to two consecutive or simultaneous analyses: one analysis by a surface recognition technology, which enables to determine the type of material (physical and/or chemical make-up) and one analysis by a volume measurement technology, which enables to determine the equivalent thickness of material.

This combination of two different types of analysis, with a combined use of the information and data collected by the two analyses, enables to know the total amount of each material advancing on the conveyor, and therefore to improve significantly the quality of sorting or else the precision of measurement of certain parameters such as the moisture level or the measurement of the lower heating value (denoted LHV). This combination can also be used for a large number of applications such as contactless dynamic weighing.

Furthermore, the process according to the invention can have one or more of the advantageous characteristics or of the variant embodiments that follow:
the radiation emitted during the use of the surface analysis processes that are applied from above and of the volume analysis processes that are applied from above or below, in relation to the flow of objects, articles or the like advancing on a conveyor belt or similar transport support, the reception of the radiation taking place above said flow after reflection or below the support after transmission;
the volume analysis process uses microwaves or UHF waves, preferentially in a range of frequencies from 1 GHz to 10 THz;
the volume analysis process uses transmission X-rays, in a range of energy of between 2 keV and 100 keV;
the surface analysis process uses infrared radiation and consists of an optical analysis process in the near- or medium-infrared or of a thermographic analysis process in the medium-infrared;
the surface analysis process is a process of analysis of atomic composition, such as a process of analysis by X-ray fluorescence or a process of analysis by laser-induced plasma spectroscopy.

Furthermore, the process according to the invention can consist:
for fibrous objects, articles or the like, in determining the moisture level from the combined results furnished by the surface and volume analysis processes, and/or,
for an advancing flow composed of or incorporating objects, articles or the like of paper and/or of cardboard, in performing a discrimination as a function of their respective total thickness of material.

Moreover, in conformity with advantageous applications of the process according to the invention, the results of the different types of analysis can be used to perform, preferentially approximately in real time, either a contactless weighing of the advancing flow of objects, articles or the like, or a LHV evaluation of the advancing flow of objects, articles or the like.

The invention also has as its object an installation for inspection and/or for automatic sorting of objects, articles or the like belonging to at least two different classes or categories, in particular for using the process described above, said installation comprising, on the one hand, a means to ensure the advancement approximately in a single layer of said objects or the like, for example a conveyor belt or a similar transport support, and, on the other hand, at least two contactless analysis means by radiation of the advancing objects, articles or the like, an installation characterized in that it further comprises a means for the combined use of the results furnished for each object, article or the like by the analysis means of different types, to perform a discrimination among these objects or the like and/or an evaluation of at least one characteristic of the latter and in that said analysis means comprise, on the one hand, at least one surface analysis means able to determine the physical and/or chemical composition of the upper or outer layer of an object or the like exposed to the radiation of this means, and, on the other hand, at least one volume analysis means able to determine the equivalent thickness of material of the same object or the like.

The data coming from the different analysis processes are stored independently in a processing unit and then pooled. The processing unit enables to time-synchronize the data and thus to reestablish the longitudinal coherence between the pixels coming from the sensors of the two analysis means, if the data coming from said sensors are obtained consecutively and not simultaneously. If the lateral resolution of the pixels differs from one sensor to the next, then these two resolutions can be reconciled by degrading, thanks to the computing system, the resolution of one or of both sensors, preferentially so that the resolution of the two combined pixels corresponds to the gap separating two consecutive ejection elements.

The invention will be better understood, thanks to the description below, which relates to preferred embodiments, given by way of nonlimiting examples, and explained with reference to the accompanying diagrammatic drawings, in which:

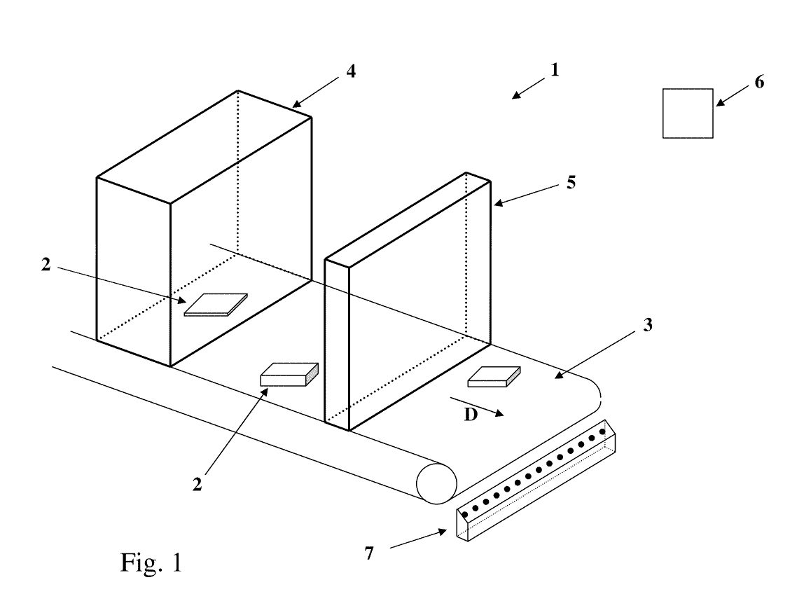

FIG. 1 is a representation in partial and simplified perspective of an installation according to a preferred embodiment of the invention;

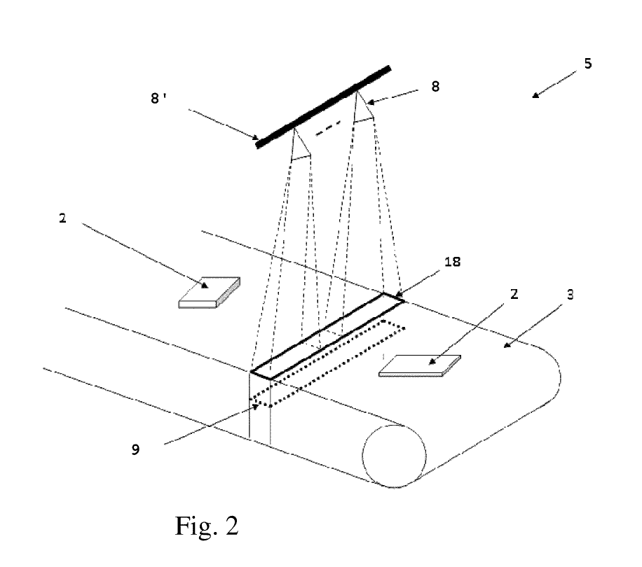

FIG. 2 is a simplified representation in perspective of a volume analysis system or means using hyperfrequency waves that can be part of the installation shown by FIG. 1;

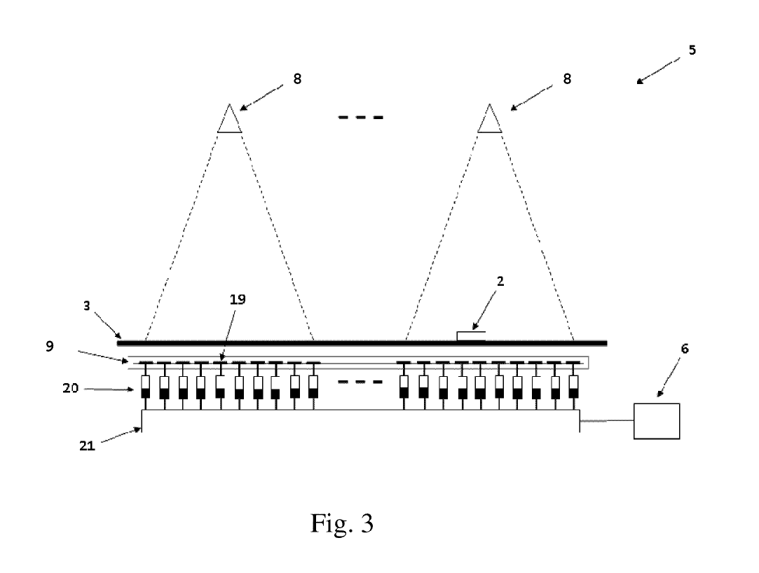

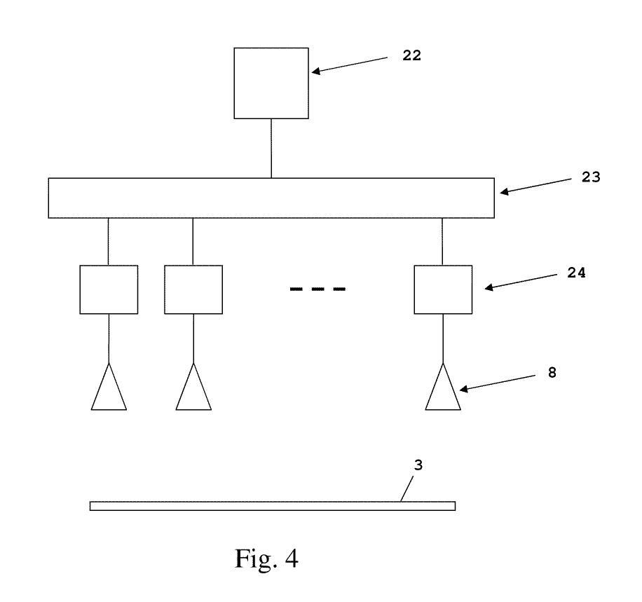

FIGS. 3 and 4 are simplified representations in section, in a direction that is perpendicular to the direction of advancement, of the analysis means using hyperfrequency waves, shown by FIG. 2, illustrating in greater detail respectively the array of receiving antennas (FIG. 3) and the array of emitting antennas (FIG. 4);

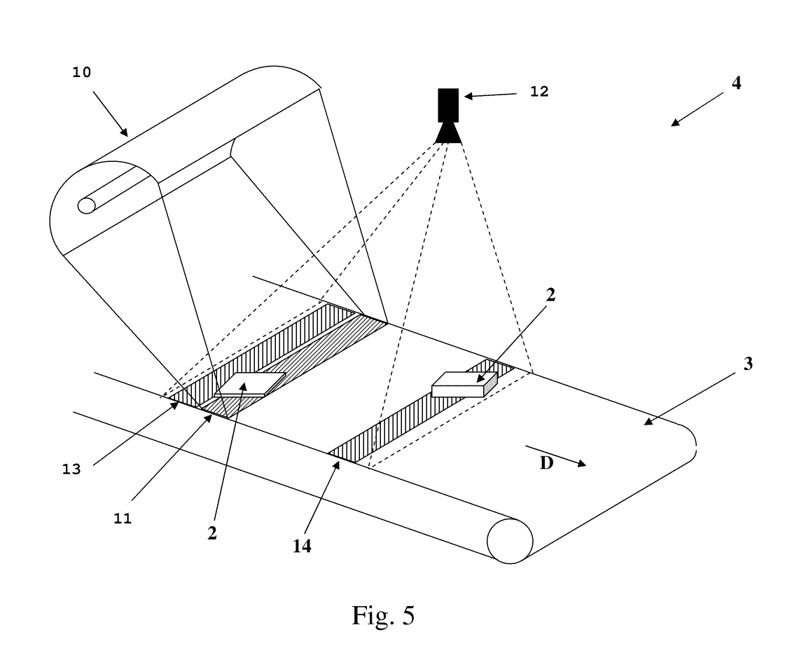

FIG. 5 is a simplified representation in perspective of a surface analysis means based on a thermographic analysis process, preferentially in the medium-infrared, that can be part of the installation shown by FIG. 1;

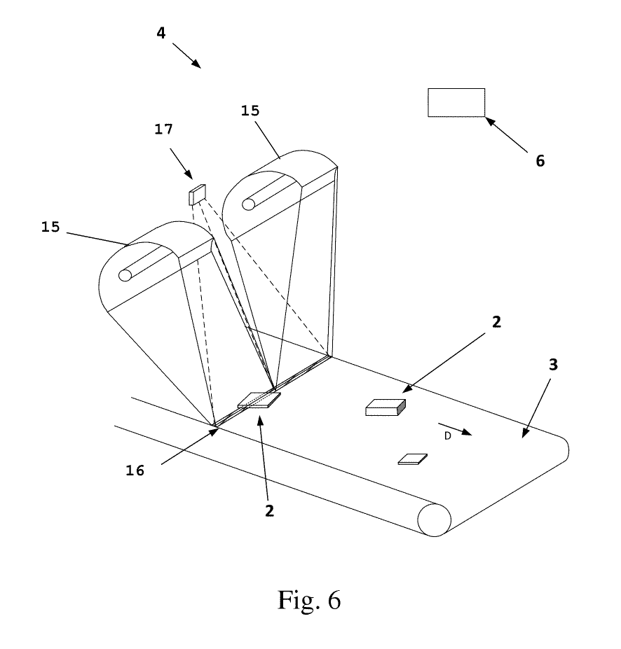

FIG. 6 is a simplified representation in perspective of a surface analysis means based on a spectroscopic or optical analysis process in the near-infrared that can be part of the installation shown by FIG. 1;

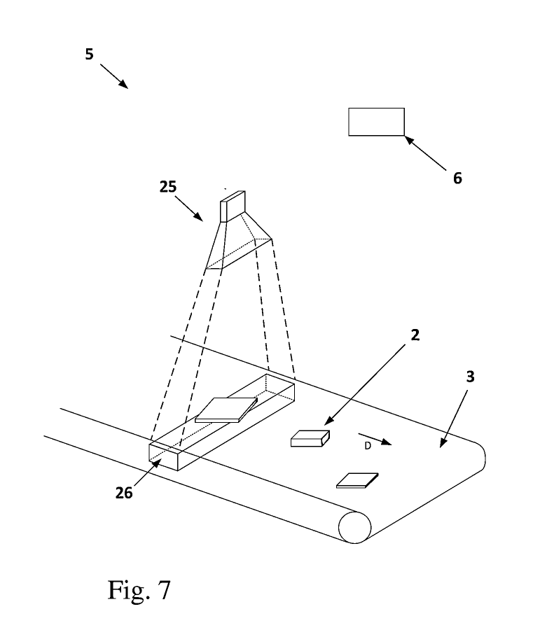

FIG. 7 is a simplified representation in perspective of a surface analysis means based on a volume analysis process using transmission X-rays that can be part of the installation shown by FIG. 1, and

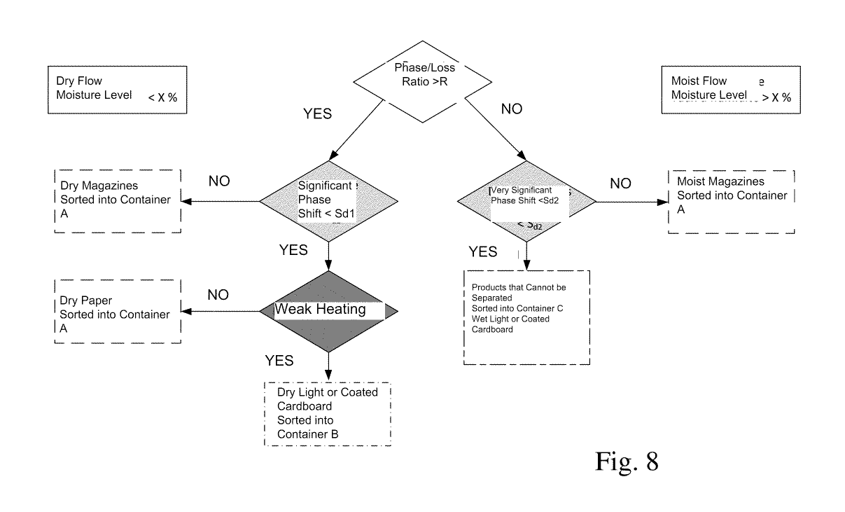

FIG. 8 is a decision-making flowchart corresponding to the combined use of the results of surface and volume analyses for the sorting of a heterogeneous papers/cardboards/magazines flow.

FIG. 1 of the accompanying drawings illustrates, by way of example and in a simplified way, an installation 1 for inspection and/or automatic sorting of objects, articles or the like 2 belonging to at least two different classes or categories. Said installation 1 comprises, on the one hand, a means 3 to ensure the advancement approximately in a single layer of said objects or the like 2, for example a conveyor belt or a similar transport support, and, on the other hand, at least two means 4 and 5 of contactless analysis by radiation of the advancing objects, articles or the like 2.

According to the invention, this installation 1 further comprises a means 6 for the combined use of the results furnished for each object, article or the like 2 by analysis means 4, 5 of different types, to perform a discrimination among these objects or the like and/or an evaluation of at least one characteristic of the latter and in that said analysis means 4, 5 comprise, on the one hand, at least one surface analysis means 4 able to determine the physical and/or chemical composition of the outer layer of an object or the like 2 exposed to the radiation of this means and, on the other hand, at least one volume analysis means able to determine the equivalent thickness of material of the same object or the like 2.

Although in FIG. 1, the installation 1 uses two consecutive analyses (the sensors of the analysis means 4 and 5 being offset spatially in the direction of advancement of the objects 2), it is also possible that these two analyses are performed simultaneously (analysis zones of the sensors merged or included in one another).

As FIGS. 2 to 4 and 7 of the accompanying drawings diagrammatically show, volume analysis means 5 can be advantageously selected from the group formed by the analysis means by hyperfrequency waves and the analysis means by transmission X-rays, the transport support 3 being preferentially essentially transparent for the radiation used.

Preferentially, the volume analysis means 5 using hyperfrequency waves, preferentially in a range of frequencies from 1 GHz to 10 THz, comprises at least one array of emitting antennas 8 and at least one array of receiving antennas 9, the unit operating at a defined working frequency in the preceding frequency range, for example of the planar antennas type, aligned in a direction perpendicular to the direction D of advancement of the objects or the like 2 to be inspected or sorted, the receiving antennas 9 being placed under the transport support 3.

According to an optimized variant embodiment, the hyperfrequency wave volume analysis means 5 comprises at least two arrays of emitting antennas 8 and receiving antennas 9, the coupled pairs of arrays 8, 9 operating at different working frequencies, the ratio between these working frequencies being at least equal to two.

Further, and as shown by FIGS. 5 and 6, by way of examples, the surface analysis means 4 can be advantageously selected from the group formed by the near- or medium-infrared optical analysis means, the medium-infrared thermography analysis means, the X-ray fluorescence analysis means, and the laser-induced plasma spectroscopy analysis means, the transport support 3 furnishing, if necessary, a contrasted background in relation to the objects or the like 2 for the analysis radiation being considered.

Of course, the installation 1 further comprises additional means (hardware and software), in particular for collecting and processing the results furnished by the analysis means 4 and 5, making it possible to use the different operations of the process described above.

In what follows, different variant embodiments of the installation and the process according to the invention are described in more detail, but in a nonlimiting way, in connection with the accompanying drawings.

As FIG. 1 shows, and as already indicated, the process according to the invention consists essentially in subjecting an object 2 advancing on a conveyor belt 3 to at least two different analyses. The first analysis is a surface analysis based on the use of a surface analysis system 4. It is possible to subject the object 2 to several surface analyses so as to further improve the characterization. The second analysis based on the use of a volume measurement system 5 enables to analyze the object 2 over its entire thickness. Also, it is possible to subject the object 2 to several volume measurement analyses for a better precision of measurement.

As indicated above, the volume measurement technology can be of different types, such as, for example, hyperfrequencies, X-rays or Gamma-rays. The order of the analyses can be of any type whatsoever. The data collected by the different analyses are then pooled in a processing unit 6, for example a data processing unit, and then analyzed to determine the characteristics of the object 2. An ejection system 7 can be provided, which enables to separate, if necessary, the objects into two or more categories.

In the description below, the preferential embodiment selected of the volume measurement system 5 will be the hyperfrequency or X-ray technology.

The surface analysis system 4 can use, depending on the targeted application, a UV/visible, infrared spectroscopy optical analysis and/or a thermographic analysis. Of course, these examples are not limiting. In all cases, the entire width of the conveyor belt 3 is subjected to an electromagnetic radiation coming from a source placed above and generating a return signal to a detector also placed above: this configuration is referred to as backscatter. Because of the slight depth of penetration of the surface wave, these technologies make it possible only to analyze the object 2 on the surface. By this analysis, the type of materials that advance on the conveyor belt 3 can be determined. For example, a spectroscopy technology using the near-infrared enables to recognize different plastics (PET, PETG, ABS, PS, etc.), with a penetration of 1 to several mm. A thermography technology with thermal radiation in the medium-infrared has a penetration of less than 100 μm. It enables, for example, to differentiate different types of paper (photocopier type A4 paper, brown corrugated cardboard, light or coated cardboards, etc.).

During the thermographic analysis (a technology known of itself) by a suitable system 4 of FIG. 5, a heat source 10 enables to send heat radiation onto a zone 11. When the object 2 crosses this zone 11, the upper layer of the object 2 undergoes a heating. A thermal camera 12 measures the temperature rise between a zone 13 before the irradiation, and a zone 14 after the irradiation. Depending on the composition of the object, the latter will have a different temperature rise. For example, for a paper/cardboard flow, the pieces of paper, being thinner, will be more heated than the pieces of cardboard, which enables to differentiate them.

During the use of an infrared spectroscopy analysis system 4 (FIG. 6—known as such), an infrared light source 15 enables to send infrared radiation into a zone 16. All of the objects 2 that advance on the conveyor belt 3 are subjected to this radiation. An image acquisition system 17 enables to sweep the conveyor belt 3 and to observe the spectrum of each object 2. A central processing unit 6 enables to collect and process the data. Each constituent material of the objects 2 has a different spectral response that enables, by comparison to models stored in a database, to determine the nature of the material of the advancing object 2.

The volume analysis can be based on the use of a hyperfrequency system 5 (FIG. 2) that enables to analyze the object 2 in its entire thickness. The object 2 is illuminated by a beam of hyperfrequency waves emitted by antennas 8, preferably of the cone type, held up by a support 8′. The wave is propagated then from the emitting antenna array 8 to the receiving antenna array 9. When the object 2 passes into the zone 18, it changes the amplitude and the phase of the hyperfrequency waves picked up by the antenna array 9. The wave is all the more attenuated the greater the loss tangent of the object 2 and all the more slowed (or out of phase) the greater its relative permittivity. The emitting antenna array 8 is located at a distance from the conveyor belt 3, making possible the free passage of the objects 2 advancing on the conveyor belt 3, i.e., preferably a distance of 150 to 300 mm.

Each antenna 8 of the emitting array illuminates a reasonable width of the conveyor belt 3 and is therefore spaced by a defined distance that depends on parameters such as the frequency, the type of antenna, and the gain of the antenna. For example, at 10 GHz, the emitting antennas 8 are spaced preferably so that each antenna illuminates a width of 20 cm or more of conveyor belt.

The receiving antenna array 9 (FIG. 3), placed under the conveyor belt 3, consists of planar antennas 19 referred to as “patch antennas” that are spaced so that there is no crosstalk between the antennas. In series with each antenna 19, a detection system 20 is connected that enables to know the modulus and/or the phase of the signal. The detection system 20 is, for example, a complex correlator as described in “The Six-Port Reflectometer: An Alternative NetworkAnalyser”, Glenn F. Enguen, IEEE Transactions on Microwave Theory and Techniques, Vol. 25, No. 12, December 1977. The measurement of phase can also be done using a slave system that superimposes the emitting signal and the receiving signal after a pre-processing that equalizes their amplitudes. When an object passes into the zone 18, the modulus and the phase of each signal are modified. These data, measured using the detection system 20, are formatted using an analog circuit 21, and then transmitted and processed by a central processing unit 6.

The hyperfrequency signal comes from a source 22 (FIG. 4) at the selected frequency that can go from several Gigahertz to several Terahertz. This signal is then divided into as many paths as necessary, using power dividers 23, to create an optimal illumination of the conveyor belt. An amplifier 24 placed upstream from each antenna 8 enables to amplify the signal. Depending on the frequency of the source 22, it is possible to use only a single amplifier placed between the source 22 and the divider 23. The detection range of the hyperfrequency system 5 is all the more broad the greater the power emitted. A power of 10 mW at the entry of each antenna 8 is suitable for a utilization frequency of 10 GHz and for an array of antennas placed at 30 cm from the conveyor belt 3.

A second type of volume analysis system 5 (FIG. 7) can also be constructed using an X-ray technology. In this case, a source 25 enables to emit X-rays over a width of conveyor belt 3. The rays that pass through the objects 2 and through the conveyor belt 3 are picked up by a detector 26. This measurement technology is sensitive to the passed through thickness of the object 2 that advances on the conveyor belt 3. Thus, it is possible to separate a thick object from an object that is less thick by knowing the constituent material of these objects 2. This last piece of information is given by the surface analysis 4.

The power of the wave through the object 2 decreases proportionally to an exponential of (α*l) where α represents the coefficient of absorption of the material and l represents the thickness of the material. α is determined thanks to the use of the surface recognition technology 4. Knowing α, it is then possible to determine l thanks to the measurement of the transmitted power of the X-rays or of the hyperfrequency waves from the emission 25 to the reception 26.

Finally, it is necessary to combine the data coming from the surface analysis systems 4 and volume analysis systems 5. The pooling of these data is achieved using a central processing unit 6. Thus, the combination of the systems 4 and 5 enables to improve the characterization and the differentiation of the objects 2 advancing on the conveyor belt 3. According to the foreseen application of the combination of the two technologies, the pooling of the data is done differently. For example, for the mass measurement application or LHV, the surface recognition technology provides the information on the type of material of the surface element analyzed, and the second analysis provides the amount of material situated vertically of this surface element. The combination of these two pieces of information enables to calculate the weight or the LHV of the objects 2.

Thanks to the preceding description, the person skilled in the art easily understands the improvements brought by the combination of the two technologies indicated.

A practical example of application of the invention is described in the following disclosure, in particular in connection with the problems linked to the sorting of papers that are described in the state of the art (limitation during the light or coated cardboard/magazine differentiation). If two objects 2 exhibit similar surface layers, it has been found that the surface analysis system 4 alone is inadequate. In the case of the example of a paper/cardboard flow, it is difficult to differentiate between a thick cover of a magazine and a light or coated cardboard (flat cardboard, of low recycling value). Now, in sorting applications, the magazines represent a significant source of paper to be recovered.

Using the sole analysis system 4 presented above, the magazines with a thick cover are considered as light or coated cardboards and are therefore not recovered optimally. In this case, the hyperfrequency system 5, used in reading mode of the modulus only, enables to perform this light or coated cardboard/magazine discrimination.

In fact, when the object 2 (light or coated cardboard or magazine) passes through the zone 18, the losses measured will be greater if the object 2 is a magazine than if it is a light or coated cardboard. Since the magazine is thicker (on average: surface mass=5 kg/m²), the hyperfrequency waves must pass through more material; they are thereby more attenuated than for a light or coated cardboard (on average: surface mass=1 kg/m²). The variation of the measured losses is of the type: P(dB)=α(f)×e, where e represents the equivalent thickness of cellulose in mm and α(f) represents the losses linked to a material of dB/mm and depends on the working frequency f. For example, at 25 GHz, α(25 GHz)=0.3 dB/mm. Generally, a magazine that has a thickness of 5 mm (120 pages) generates about 1.5 dB of losses. On the other hand, a calendar-type light or coated cardboard (thickness 2 mm) generates only about 0.6 dB of losses. Thus, whereas it was not possible to differentiate a light or coated cardboard from a magazine using the only surface analysis system 4, it is possible to make this differentiation using in addition the hyperfrequency system 5.

For example, assuming a limit of losses of 0.7 dB, it is possible to consider that any object 2 that generates losses greater than this limit is a magazine. In the opposite case, it is considered as a light or coated cardboard.

More generally, the description of the preceding practical variant is applied to the distinction of objects 2 having a cellulose base that differ between one another by the total thickness of material present.

The volume analysis system 5 also enables to improve the differentiation of products in the presence of moisture. This application can be explained using the hyperfrequency system. This system enables to check if the object 2 that circulates on the conveyor belt 3 is moist or not. Actually, a wet material generates greater losses (the water having a high coefficient of absorption at the hyperfrequencies) and also generates a greater phase shift or delay on the wave (the water having a higher permittivity at the hyperfrequencies).

The phase shift of a wave propagating in a relative permittivity medium εᵣ can be written in the form:

$$Φ = \frac{2 π f \sqrt{{ɛ}_{r}}}{c} \times d$$

where Φ is expressed in radian, f represents the frequency of the signal, c represents the speed of light in the vacuum, and d represents the distance of propagation in the object.

If a movement of the wave over a distance of 1 mm is considered, then the following phase shifts are obtained:
for a propagation in air (εᵣ=1), and at 10 GHz, Φ=12°.
for a propagation in dry wood (εᵣ=1.8), and at 10 GHz, Φ=16.1°.
for a propagation in dry paper (εᵣ=2.1), and at 10 GHz, Φ=17.1°.
for a propagation in water (εᵣ=30), and at 10 GHz, Φ=65°.

We note that water generates a phase shift about four times greater than that generated by dry wood or paper. In contrast, its absorption is forty times greater than for wood or paper. Since these two ratios are different, it is possible, by knowing the modulus and the phase of the wave, to recognize the moist materials, indeed even to measure their water content. By knowing the information about the moisture of the material (furnished by the hyperfrequency system 5), as well as the thermal behavior of different flows as a function of moisture, a correction can be made to the measurement taken by the thermography system 4 to improve the discrimination.

The following table provides an estimate of the phase and the losses measured for two types of samples and two levels of moisture at a 10 GHz frequency:

| Type of | | Measured | Measured | Phase/Loss |
|---|---|---|---|---|
| materials | Characteristics | Phase | Losses | Ratio |
| Magazine | 20% Wet | 150° | 6.8 dB | 22 |
| 5 mm thick | Dry | 85° | 0.7 dB | 121 |
| Light or | 20% Wet | 30° | 1.2 dB | 25 |
| coated | Dry | 17° | 0.14 dB | 121 |
| cardboard | | | | |
| 1 mm thick | | | | |

To differentiate the objects 2 from one another, whether they are wet or dry, the processing unit 6 can, for example, execute the instructions indicated in the flowchart in the form of a block diagram of FIG. 8.

If the Phase/Loss ratio is less than a certain value R (a function of the frequency, for example 100 at 10 GHz), then the moisture level is greater than X %, X being generally equal to about 10%. In this case, the value of the phase shift is measured. If the latter is greater than a threshold value S_{d2} (depends on the frequency, for example 120° at 10 GHz), then the object 2 being tested is a moist magazine and will be placed in the container A of the products to be recovered. Otherwise, this means that it is not possible to determine precisely the nature of the object 2, and the latter will then be placed in the container C of contaminated products (wet light or coated cardboard).

If the Phase/Loss ratio is greater than a certain value R (for example 100 at 10 GHz), then the level of moisture of the flow is less than X %. Then, the phase of the signal is measured. If this phase is:
greater than a threshold value S_{d1} (for example 70° at 10 GHz), then the object 2 that is advancing on the conveyor belt 3 is a dry magazine. It will then be placed in the container A.
less than a threshold value S_{d1}, the object 2 is subjected to a thermography analysis. If there is measured:
a strong heating, the object 2 is dry paper. It will then be placed in the container A.
a weak heating, the object is a dry light or coated cardboard. It will be placed in the container B. As is evident from the preceding application, the hyperfrequency system 5 enables to measure the level of moisture. Thus, considering this system alone, it becomes possible to measure the level of moisture of a flow of objects 2 having a moisture level less than 20% that advances on the conveyor belt 3. The measurement of the phase/loss ratio (degree/dB) provides, by a reference curve, the moisture level for moisture levels less than 20%. Beyond 20% moisture, the variation of the phase/loss ratio becomes too slight relative to the variation of the moisture level. For a moisture measurement greater than 20%, a surface recognition NIR technology is used. By combining these two technologies, a measurement is then obtained of the moisture level for materials having between 0 and 100% moisture.

Another application of this invention, using the combination of a surface recognition system 4 and a volume measurement system 5, is the performing of a contactless weighing. This application preferentially encompasses the use of the hyperfrequency or X-ray system 5 with the surface recognition system 4 by infrared spectroscopy or X-ray fluorescence.

In this application, the surface recognition system 4, for example by infrared spectroscopy, enables to determine the constituent material i of the surface element dS of the object 2, which is advancing on the conveyor belt 3.

Then, the volume measuring system 5 makes a measurement of the transmission losses due to the object 2 that is advancing on the conveyor belt 3. Associated with each material i is an absorption A, (expressed in dB/(kg/m²) for a hyperfrequency technology), this coefficient depending mainly on the density of the object.

It is therefore from the measurement of the losses p that it is possible to estimate the mass of the flow that is advancing on the conveyor belt 3. Associated with each unitary surface dS measured by the package 14 is a mass dMi=p·dS/Aᵢ. Finally, a central processing unit 6 enables to add the elementary masses measured and therefore to estimate the total mass of the flow that is advancing on the conveyor belt, as well as the total mass of each material, and therefore the mass proportions of the flow.

In the case of a hyperfrequency volume recognition technology, the applied coefficients depend on the working frequency of the volume measuring system 5.

Thus, a thin object 2 will require a high frequency analysis (a frequency of 90 GHz is suitable for a thickness of objects on the order of 0.2 mm or more) and a thick object will require a low frequency analysis (a frequency of 10 GHz is suitable for a thickness of objects on the order of 2 mm or more).

In the case where the flow advancing on the conveyor belt 3 presents objects 2 of different thicknesses, the hyperfrequency system 5 can be composed of two arrays of antennas 8 and 9, each antenna array then having a different working frequency. Two absorptions are thus assigned to each type of materials, one for each working frequency.

From the application of contactless weighing, different applications result such as the measurement of the higher and lower heating value, and the measurement of the biomethanation potential, the measurement of the proportion of a characteristic in a material such as the level of chlorine, etc.

For example, in the case of the heating value LHVLHV, the principle remains the same as for the contactless weighing except that this time, associated with each material is the LHV Ci of the material i in MJ/kg. The LHV dC of each pixel is then dC=Cᵢ·dMᵢ, where dMᵢ is calculated by the preceding formula. Then, the measurement of the LHV of a flow of objects 2 is obtained by adding the LHVs of all of the pixels of the flow that is advancing on the conveyor belt 3.

Considering the characteristics mentioned in this document, additional characteristics disclosed in the various documents cited in the introduction relating to the known technologies of volume and surface analysis and of the knowledge of a person skilled in the art, it is not necessary to describe further the means used by the invention.

It is evident from the preceding that this invention relates to the application of the combination of at least two technologies (at least one surface analysis technology and at least one volume measurement technology) for the characterization and/or the sorting in real time of objects 2 and particularly:
the improvement of the distinction of light or coated cardboards/magazines.
the measurement of the overall moisture level of a material.
the contactless weighing of a flow of heterogeneous objects.
the measurement of the lower heating value of a flow of heterogeneous objects.
the measurement of the upper heating value of a flow of heterogeneous objects.
the measurement of the biomethanation potential of a flow of heterogeneous objects.
the measurement of the level of chlorine, etc.

For this purpose, the invention uses a surface measurement to characterize and/or to sort objects exhibiting different absorptions thanks to the use of the surface recognition technology and a volume measurement technology that analyzes the object in its entire thickness. Different types of surface analyses can be used such as, for example, thermography or infrared spectroscopy, or UV/visible spectroscopy. The purpose of the surface analysis is to determine the type of material that is advancing on the conveyor belt.

For the volume analysis, it is, for example, possible to use X-ray, Gamma-ray or hyperfrequency waves. The response of these technologies depends on the equivalent thickness of the material that is passed through, i.e., the thickness that the material would have in the absence of possible gaps.

The combination of the surface recognition and volume measurement technologies has as its main object to increase the purity and the quality of the sorting in real time and to improve the characterization of the advancing objects, particularly the measurement of the mass.

By knowing the nature of the material, its properties are known, such as the absorption and the phase shift per unit of thickness and the density of this material. The combination of the surface information with the quantity of material present per unit of surface enables to estimate the mass of the object. Thus, a contactless weighing can be performed. By multiplying the masses of the objects by the LHV of their constituent material, the total LHV of this material in the flow is obtained.

The information of the mass is, for example, necessary for the operator of a materials recovery facility for the management of the site in real time. The information on the LHV of a certain quantity of objects enables to know, for example, the energy that will be released by these objects if they are recovered thermally, that is to say incinerated with energy recovery.

Of course, the invention is not limited to the embodiments described and shown in the accompanying drawings. Modifications remain possible, particularly from the viewpoint of the make-up of the various elements or by substitution of equivalent techniques, without thereby going outside the field of protection of the invention.

1-16. (canceled)

17. Automatic process for inspection and/or for sorting of objects, articles or the like, belonging to at least two different categories and made to advance approximately in a single layer, for example on a conveyor belt or a similar transport support, a process characterized in that it consists in subjecting the advancing flow of objects, articles or the like (2) to at least two different types of contactless analysis by radiation, whose results are used in a combined manner for each object, article or the like (2), to perform a discrimination among these objects, articles or the like (2) and/or an evaluation of at least one characteristic of the latter, the analyses used comprising, on the one hand, at least one surface analysis process able to determine the physical and/or chemical composition of the upper or outer layer of an object or the like (2) exposed to the radiation used in this process and, on the other hand, at least one volume analysis process able to determine the equivalent thickness of material of the same object or the like (2).

18. Process according to claim 17, wherein it comprises the processing of the objects, articles or the like (2) by a surface analysis process and by a volume analysis process, said objects, articles or the like (2) being subjected, successively or simultaneously, to each of the analysis processes during their advancement in single-layer flow.

19. Process according to claim 17, wherein the volume analysis process uses microwaves or UHF waves, preferentially in a range of frequencies from 1 GHz to 10 THz.

20. Process according to claim 17, wherein the volume analysis process uses transmission X-rays, in an energy range of between 2 keV and 100 keV.

21. Process according to claim 17, wherein the surface analysis process uses an infrared radiation and consists of an optical analysis process in the near- or medium-infrared or of a thermographic analysis process in the medium-infrared.

22. Process according to claim 17, wherein the surface analysis process is a process of analysis of atomic composition, such as, for example, a process for analysis by X-ray fluorescence or
a process for analysis by laser-induced plasma spectroscopy.

23. Process according to claim 17, wherein it consists, for fibrous objects, articles or the like (2), in determining the moisture level from the combined results furnished by the surface and volume analysis processes.

24. Process according to claim 17, wherein it consists, for an advancing flow composed of or incorporating objects, articles or the like (2) of paper and/or of cardboard, in performing a discrimination as a function of their respective total thickness of material.

25. Process according to claim 17, wherein the results of the different types of analysis are used to perform, preferentially approximately in real time, a contactless weighing of the advancing flow of objects, articles or the like (2).

26. Process according to claim 17, wherein the results of the different types of analysis are used to perform, preferentially approximately in real time, an evaluation of the lower heating value, of the upper heating value, of the biomethanation potential, and/or the chlorine level of the advancing flow of objects, articles or the like (2).

27. Installation for inspection and/or for automatic sorting of objects, articles or the like belonging to at least two different classes or categories, in particular for using the process according to claim 17, said installation comprising, on the one hand, a means to ensure the advancement approximately in a single layer of said objects or the like, for example a conveyor belt or a similar transport support, and, on the other hand, at least two contactless analysis means by radiation of the advancing objects, articles or the like, an installation (1) wherein it further comprises a means (6) for the combined use of the results furnished for each object, article or the like (2) by the analysis means (4, 5) of different types, to perform a discrimination among these objects or the like and/or an evaluation of at least one characteristic of the latter and in that said analysis means (4, 5) comprise, on the one hand, at least one surface analysis means (4) able to determine the physical and/or chemical composition of the upper or outer layer of an object or the like (2) exposed to the radiation of this means and, on the other hand, at least one volume analysis means able to determine the equivalent thickness of material of the same object or the like (2).

28. Installation according to claim 27, wherein the volume analysis means (5) is selected from the group formed by the analysis means by hyperfrequency waves and the analysis means by transmission X-rays, the transport support (3) being preferentially essentially transparent for the radiation used.

29. Installation according to claim 27, wherein the surface analysis means (4) is selected from the group formed by the near- or medium-infrared optical analysis means, the medium-infrared thermography analysis means, the X-ray fluorescence analysis means, and the laser-induced plasma spectroscopy analysis means, the transport support (3) furnishing, if necessary, a contrasted background in relation to the objects or the like (2) for the analysis radiation being considered.

30. Installation according to claim 28, wherein the volume analysis means (5) using hyperfrequency waves, preferentially in a range of frequencies from 1 GHz to 10 THz, comprises at least one array of emitting antennas (8) and at least one array of receiving antennas (9), the unit operating at a defined working frequency in the preceding frequency range, for example of the planar antennas type, aligned in a direction perpendicular to the direction (D) of advancement of the objects or the like (2) to be inspected or sorted, the receiving antennas (9) being placed under the transport support (3).

31. Installation according to claim 30, wherein the hyperfrequency wave volume analysis means (5) comprises at least two arrays of emitting antennas (8) and receiving antennas (9), the coupled pairs of arrays (8, 9) operating at different working frequencies, the ratio between these working frequencies being at least equal to two.

32. Installation according to claim 27, wherein it further comprises additional means, in particular for processing the results furnished by the analysis means (4 and 5).

33. Installation according to claim 28, wherein the surface analysis means (4) is selected from the group formed by the near- or medium-infrared optical analysis means, the medium-infrared thermography analysis means, the X-ray fluorescence analysis means, and the laser-induced plasma spectroscopy analysis means, the transport support (3) furnishing, if necessary, a contrasted background in relation to the objects or the like (2) for the analysis radiation being considered.

34. Installation according to claim 29, wherein the volume analysis means (5) using hyperfrequency waves, preferentially in a range of frequencies from 1 GHz to 10 THz, comprises at least one array of emitting antennas (8) and at least one array of receiving antennas (9), the unit operating at a defined working frequency in the preceding frequency range, for example of the planar antennas type, aligned in a direction perpendicular to the direction (D) of advancement of the objects or the like (2) to be inspected or sorted, the receiving antennas (9) being placed under the transport support (3).

35. Process according to claim 18, wherein the volume analysis process uses microwaves or UHF waves, preferentially in a range of frequencies from 1 GHz to 10 THz.

36. Process according to claim 18, wherein the volume analysis process uses transmission X-rays, in an energy range of between 2 keV and 100 keV.
